(19) United States
(12) Patent Application Publication
(10) Pub. No.: US 2004/0010428 A1
(43) Pub. Date: Jan. 15, 2004

(54) System and method for controlling logistics

(76) Inventors: Chun-Zhi Lee, Tu-Chen (TW); Qiong-Shuai Chen, Shenzhen (CN); Wei-Hua Guan, Shenzhen (CN); Zhiyong Wu, Shenzhen (CN); Wen-Zhen Ma, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/280,453

(22) Filed: Oct. 25, 2002

(30) Foreign Application Priority Data
Jul. 10, 2002 (TW) 091115315

(51) Int. Cl. G06F 17/60

(52) U.S. Cl. 705/6

(57) ABSTRACT

A system for controlling logistics via a graphic user interface (GUI). The system includes a database server (1) and a web server (2). The database server includes a database (10) for storing freight data, and data on freight routes. The web server includes a route storage (20), a conveyance model storage (22), a route generator (24), and an active conveyance generator (26). The web server can generate an active freight route map (866), including freight routes (8664) and conveyance simulators (8666) moving along the freight routes. Each route in the freight route map is hyperlinked to in-transit freight data on the freight route. Each conveyance simulator is hyperlinked to freight data on a corresponding actual conveyance. A method for controlling logistics via a graphical user interface is also disclosed.

### BACKGROUND OF THE INVENTION

1. Field of the Invention

The present invention relates to systems and methods for controlling logistics, and particularly to a system and method for controlling logistics via a graphical user interface (GUI).

2. Background of the Invention

With the progress of science and technology and the development of the global economy, the world wide web and worldwide markets are continuing to grow. Competition between enterprises in worldwide markets is becoming more intense. Efficient control of logistics is key to an enterprise being able to compete effectively. In many developed countries, logistics costs account for 10 percent of gross national product (GNP). In China, logistics costs account for 15 percent of GNP, and 40 percent of the cost of commercial products. Logistics management is equally significant at the enterprise level. In order to manage logistics efficiently, transfer of logistics information is especially important.

These days, a typical method used for transmitting logistics information is: a user storing information on logistics in a database; and other users querying the information in the database by entering relevant keywords. Examples of like methods are disclosed in U.S. Pat. No. 6,148,291 entitled “Container and inventory monitoring methods and systems,” and U.S. Pat. No. 5,631,827 entitled “Logistics system for automating transportation of goods.” One of shortcomings of these methods is that when a user wants to query freight information on a freight route, he/she must know a flag of the freight route such as a freight route code. However, if the user is not an administrator, he/she may not know any flag. In such case, the user cannot quickly obtain the information on the freight route. Furthermore, when the user queries information on logistics with relevant keywords, he/she cannot receive a graphic image display of the information.

### SUMMARY OF THE INVENTION

Accordingly, an object of the present invention is to provide a system and method for controlling logistics that enables querying of information on logistics quickly and conveniently.

Another object of the present invention is to provide a system and method for controlling logistics that enables queried information on logistics to be presented as a graphic image display.

In order to accomplish the above-mentioned objects, the present invention provides a system and method for controlling logistics via a graphical user interface. A preferred embodiment of the system comprises a database server and a web server. The database server comprises a database for storing freight data, and data on freight routes. The web server comprises: a route storage for storing predefined route models based on the data on freight routes, the predefined route models comprising information on sites along the freight routes and information on directions of the freight routes; a conveyance model storage for storing simulators of various conveyances used for transporting articles; a route generator for generating an active freight route map including freight routes by invoking the predefined route models in the route storage; and an active conveyance generator for motivating conveyance simulators to move along the generated freight routes. Each route in the freight route map is hyperlinked to in-transit freight data on the freight route. Each conveyance simulator is hyperlinked to freight data on a corresponding actual conveyance.

A preferred embodiment of the method comprises the steps of: (i) generating keywords on sites and mode of logistics, and transmitting the keywords to a web server; (ii) querying a route storage according to the keywords, and generating an active freight route map comprising at least one freight route; (iii) generating a request according to the keywords generated in step (i), and transmitting the request to a database server; (iv) querying freight data in a database according to the generated request; and (v) invoking conveyance simulators according to the freight data, and motivating the conveyance simulators to move along the freight routes.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of infrastructure of a system for controlling logistics in accordance with a preferred embodiment of the present invention;

FIG. 2 is a schematic diagram of functional infrastructure of a web server of the system of FIG. 1;

FIG. 3 schematically illustrates an exemplary home page screen display on a browser connected with the system of FIG. 1;

FIG. 4 illustrates an exemplary logistics control screen display in accordance with a preferred embodiment of the present invention; and

FIG. 5 is a flowchart of generating an active freight route map, in accordance with the preferred embodiment of the present invention.

### DETAILED DESCRIPTION OF PREFERRED EMBODIMENTS OF THE INVENTION

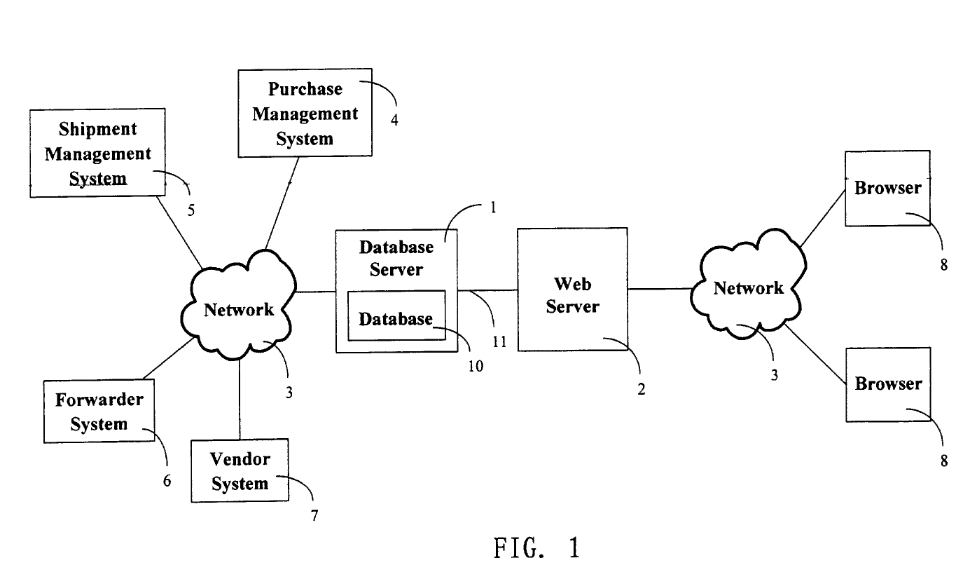

FIG. 1 is a schematic diagram of infrastructure of a system for controlling logistics in accordance with a preferred embodiment of the present invention. The system for controlling logistics is an application system based on Browser/Server (B/S) infrastructure. The system for controlling logistics comprises a database server 1, a web server 2, and plurality of outer systems. In the preferred embodiment of the present invention, the outer systems comprise a purchase management system 4, a shipment management system 5, a plurality of forwarder systems 6 (only one shown), and a plurality of vendor systems 7 (only one shown). The database server 1 is linked to the outer systems via a network 3, for exchanging of information. For example, the database server 1 can receive purchase data of an enterprise from the purchase management system 4, obtain shipment data of the enterprise from the shipment management system 5, obtain freight data of a forwarder from the forwarder system 6, or acquire shipment data of a vendor from the vendor system 7. The database server 1 can integrate the received data to generate freight data, freight route data, data on articles held at various sites, and so on. The database server 1 includes a database 10. The database 10 is used for storing the freight data, freight route data, data on articles held at various sites, and so on. The freight data comprise place of origin, destination, freight route code, voyage number or flight number, article name, article quantity, departure date, estimated time of arrival, customer name, vendor name, and forwarder name. The freight route data comprise route name, route code, place of origin, destination, mode of shipment, and sites on route. The data on articles held at various sites record inventory data for all sites of an enterprise. The inventory data comprise site name, article name, article code, and article quantity.

The web server 2 is used for controlling logistics. A user can access the web server 2 via its Internet address. The web server 2 is linked to the database server 1 via an intranet 11. A user at a browser 8 can send a request via the network 3 to the database server 1. The database server 1 queries the database 10 according to the request, and returns a received answer to the request to the web server 2. The web server 2 displays the answer through the browser 8.

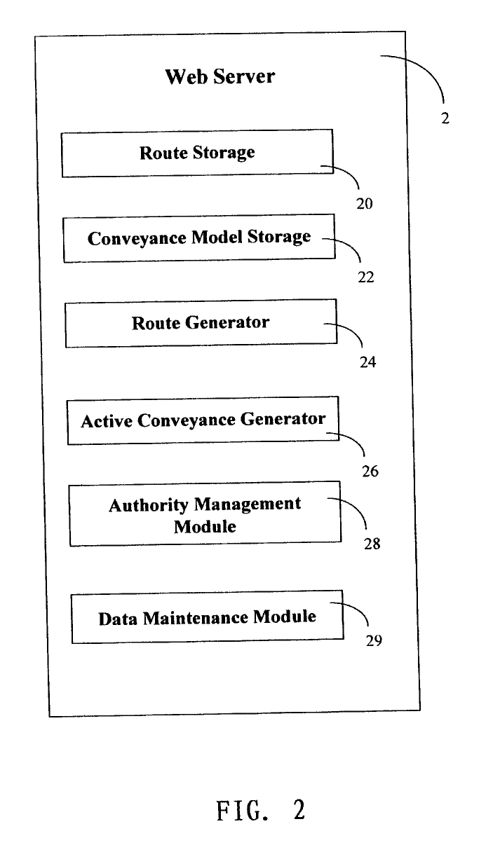

FIG. 2 is a schematic diagram of functional infrastructure of the web server 2. The web server 2 comprises a route storage 20, a conveyance model storage 22, a route generator 24, an active conveyance generator 26, an authority management module 28, and a data maintenance module 29. The route storage 20 is used for predefining and storing models of various freight routes according to freight route data. The models can simulate actual freight routes of an enterprise. The models comprise information on sites along the various freight routes, and directions of conveyance along the various freight routes. The conveyance model storage 22 is used for storing simulators of various conveyances for transferring articles. The simulators of various conveyances comprise ship simulators and airplane simulators. The route generator 24 is used for generating active freight route maps based on information on sites and mode of shipment in the web server 2. This is done by invoking the models of various freight routes in the route storage 20. The active conveyance generator 26 can invoke and motivate the simulators of various conveyances in the conveyance model storage 22 to move along the generated freight route map. The authority management model 28 is used for managing authorities of various users who access the web server 2. In the preferred embodiment of the present invention, various users have different authorities in controlling logistics. The data maintenance model 29 is used for maintaining data generated during logistics control, such as defining, modifying, adding, deleting and querying the generated data. The data generated comprise data on vendors, data on customers, freight route data, data on sites, and data on articles.

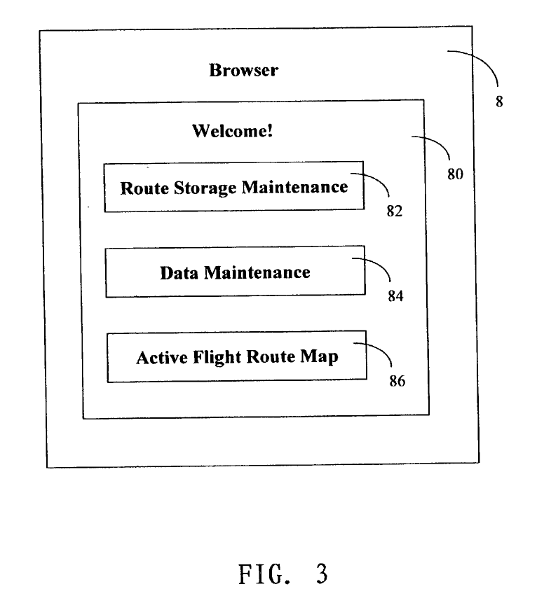

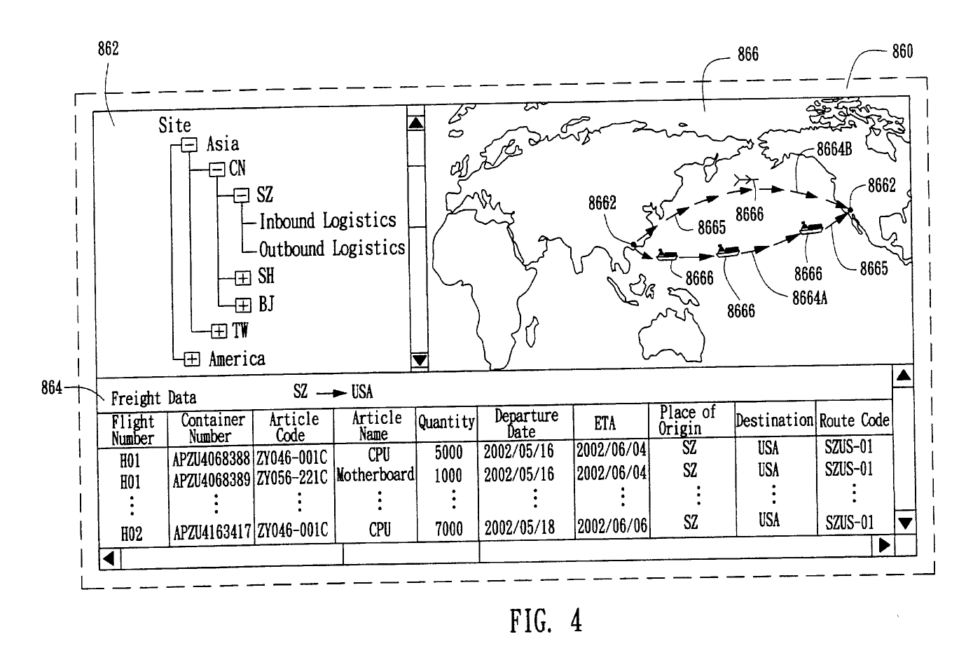

FIG. 3 schematically illustrates an exemplary home page screen display 80 on one browser 8. The home page screen display 80 includes three function buttons: a route storage maintenance button 82, a data maintenance button 84, and an active freight route map button 86. When a user clicks the route storage maintenance button 82, the user can modify data in the route storage 20. For example, the user can add a new model of a freight route when the freight route is needed, or delete a model of a freight route when the freight route is abandoned, or modify a model of a freight route when data on the freight route is changed. When the user clicks the data maintenance button 84, which is hyperlinked to the data maintenance module 29 in the web server 2, the user can add, delete and modify data comprising freight data and freight route data. When the user clicks the active freight route map button 86, a logistics control screen display 860 (as illustrated in FIG. 4) is shown through the browser 8.

FIG. 4 illustrates an exemplary logistics control screen display 860 in accordance with a preferred embodiment of the present invention. The logistics control screen display 860 comprises a site tree 862, a freight data table 864, and an active freight route map 866. The site tree 862 is used for showing sites of an enterprise. In the preferred embodiment of the present invention, the sites are located all over the world, and are shown in order of continent, country, and country locality. For example, the enterprise may have branches in Asia and America. In Asia, the enterprise has branches in China (CN) and Taiwan (TW). In China, the enterprise has three branch sites at Shenzhen (SZ), Shanghai (SH) and Beijing (BJ). At the Shenzhen site, modes of logistics comprise inbound logistics and outbound logistics. All the above-mentioned information can be shown in the site tree 862. The freight data table 864 records in-transit freight data comprising voyage number or flight number, container number, article code, article name, article quantity, departure date, estimated time of arrival (ETA), place of origin, destination, and route code. The active freight route map 866 is used for graphically displaying a selected site in the site tree 862 and a freight route relating to the selected site.

In the preferred embodiment of the present invention, the active freight route map 866 comprises a plurality of sites 8662, a plurality of freight routes 8664, and a plurality of conveyance simulators 8666. The freight routes 8664 comprise ocean shipping routes and air routes. The conveyance simulators 8666 comprise ship simulators and airplane simulators.

Each freight route 8664 comprises a series of arrows 8665, and a plurality of conveyance simulators 8666. The arrows 8665 are hyperlinked to in-transit freight data on the freight route 8664. The in-transit freight data comprise voyage number or flight number, container number, article code, article name, article quantity, departure date, estimated time of arrival (ETA), place of origin, destination and route code. A number of the conveyance simulators 8666 on a particular freight route 8664 corresponds to a number of conveyances in progress along the actual freight route represented by the particular freight route 8664. The conveyance simulators 8666 are hyperlinked to information on actual conveyances that they represent. The information on actual conveyances comprises voyage number or flight number, forwarder, freight route, and ETA. Furthermore, the conveyance simulators 8666 are hyperlinked to corresponding freight data. When a conveyance simulator 8666 is clicked, the web server 2 queries corresponding freight data in the database 10, and displays the freight data via the browser 8. The freight data comprise container number, article code, article name, article quantity, departure date, ETA, place of origin, mode of shipment, forwarder, and route code. The sites 8662 are hyperlinked to corresponding article information. The article information for each site 8662 comprises site name, article name, article code, and article quantity. When a site 8662 is clicked, the web server 2 queries the corresponding article information in the database 10, and displays the article information via the browser 8.

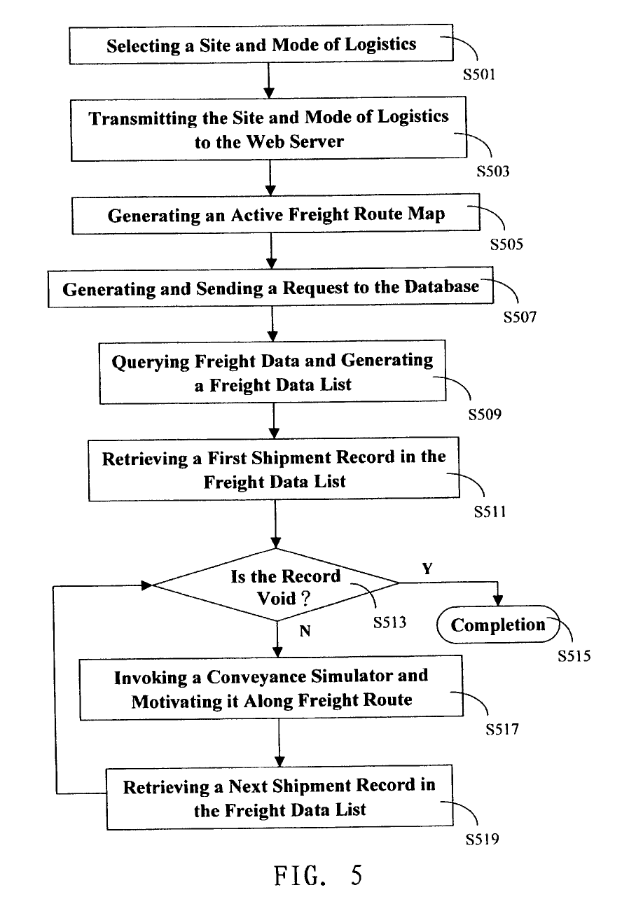

FIG. 5 is a flowchart of generating an active freight route map, in accordance with the preferred embodiment of the present invention. A user can access the web server 2 via any browser 8. When the user clicks the active freight route map button 86 (see FIG. 3), the browser 8 displays the logistics control screen display 860 (see FIG. 4). The user can select a mode of logistics for a particular site in the site tree 862 by clicking on the desired item (step S501). For example, the user clicks on “Inbound Logistics” under “SZ” (“SZ” means Shenzhen, China) in the site tree 862. Then the “SZ” and “Inbound Logistics” items are transmitted to the web server 2 (step S503). The web server 2 activates the route generator 24. The route generator 24 queries the route storage 20 according to the “SZ” and “Inbound Logistics” items, and generates an active freight route map 866 (step S505). Meanwhile, the web server 2 generates a request according to the “SZ” and “Inbound Logistics” items, and sends the request to the database server 1 (step S507). The request comprises site information “SZ,” mode of logistics “Inbound Logistics,” and current date. The database server 1 queries freight data in the database 10 according to the request, and obtains shipment records on SZ as the place of origin. The shipment records include departure dates that are prior to the current date, and ETAs that are after the current date. The database server 1 generates a freight data list based on the shipment records (step S509). Shipments recorded in the freight data list are arranged in order of departure date.

Then the active conveyance generator 26 in the web server 2 retrieves the first shipment record in the freight data list (step S511), and determines whether the first record is void (step S513). If the first record is void, the procedure is completed (step S515). If the first record is not void, and the mode of shipment in the first record is ocean shipping, the web server 2 calculates a current position of the conveyance simulator 8666 according to the following formula: P=((CD-DD)/(EDA-DD))*L, wherein P represents a current position of the conveyance simulator 8666, CD represents current date, DD represents departure date, ETA represents estimated date of arrival, and L represents length of freight route. The active conveyance generator 26 invokes a ship simulator 8666 in the conveyance model storage 22, and motivates the ship simulator 8666 to move along the freight route and stop at the calculated current position. If the mode of shipment in the first record is air shipment, the active conveyance generator 26 invokes an airplane simulator 8666 in the conveyance model storage 22, and motivates the airplane simulator 8666 to move along the freight route and stop at a middle point of the freight route (step S517). After the relevant ship or airplane simulator 8666 stops, the active conveyance generator 26 retrieves a next record in the freight data list (step S519). The active conveyance generator 26 returns to step S513, and continues to operate according to the applicable above-described steps.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A system for controlling logistics via a graphical user interface, the system comprising:
a database server, which comprises a database for storing freight data and data on freight routes; and
a web server, comprising:
a route storage for storing predefined route models based on the data on freight routes, the predefined route models comprising information on sites along the freight routes and information on directions of the freight routes;
a conveyance model storage for storing simulators of various conveyances used for transporting articles;
a route generator for generating at least one freight route by invoking the predefined route models in the route storage; and
an active conveyance generator for motivating simulators to move along the at least one freight route.

2. The system as claimed in claim 1, wherein the database server receives purchase data, shipment data and freight data via a network, and generates the freight data and data on freight routes.

3. The system as claimed in claim 1, wherein the information on sites along various routes and information on directions of the freight routes are graphically shown using a browser.

4. The system as claimed in claim 1, wherein the at least one freight route is hyperlinked to in-transit freight data on the freight route.

5. The system as claimed in claim 4, wherein the in-transit freight data comprise voyage number or flight number, container number, article code, article name, article quantity, departure date, estimated time of arrival, place of origin, destination, and route code.

6. The system as claimed in claim 1, wherein the simulators are hyperlinked to freight data on the corresponding conveyances.

7. The system as claimed in claim 6, wherein the freight data on the corresponding conveyances comprise container number, article code, article name, article quantity, departure date, estimated time of arrival, place of origin, mode of shipment, forwarder, and route code.

8. The system as claimed in claim 1, wherein the simulators comprise ship simulators and airplane simulators.

9. A method for controlling logistics, the method comprising the steps of:
(a) generating keywords on at least one site and on a mode of logistics, and transmitting the keywords to a web server;
(b) querying a route storage according to the keywords, and generating a freight route map comprising at least one freight route;
(c) generating a request according to the keywords generated in step (a), and transmitting the request to a database server;
(d) querying freight data in a database according to the generated request; and
(e) invoking at least one conveyance simulator according to the freight data, and motivating the at least one conveyance simulator to move along the at least one freight route.

10. The method as claimed in claim 9, wherein the freight route map comprises at least two sites.

11. The method as claimed in claim 9, wherein the mode of logistics comprises inbound logistics and outbound logistics.

12. A method of displaying motion graphic image of carriers having freights comprising steps of:
providing a route storage with a plurality of predefined routs including information on sites along freight routs and that on directions thereof;
displaying a freight route map including a specific freight route retrieved from said route storage according to specific designated freights;
providing a conveyance model storage with a plurality of various conveyances;
displaying a specific conveyance, which is retrieved from said conveyance model storage and carrying said specific freights on the freight route map, in a motion mood along said freight route while terminating at a position where is distanced from an original transportation site with a ratio to a full distance to a destination site, wherein said ratio is essentially equal to that between a passed time period measured from beginning of transportation and an estimate transportation time for whole transportation.
